(19) United States
(12) Patent Application Publication
(10) Pub. No.: US 2025/0100679 A1
(43) Pub. Date: Mar. 27, 2025

(54) An improved propulsion system for a helicopter

(71) Applicant: Wayne Avellanet, Plano, TX (US)

(72) Inventor: Wayne Avellanet, Plano, TX (US)

(21) Appl. No.: 18/372,067

(22) Filed: Sep. 23, 2023

(51) Int. Cl. B64C 27/12; B64C 27/473; B64C 39/02; B64D 27/02

(52) U.S. Cl. CPC B64C 27/12; B64C 27/473; B64C 39/024; B64D 27/02

(57) ABSTRACT

A helicopter transporting at least one user, including a cockpit for carrying at least the one user; a circular concentric apparatus (CCA) being connected to the cockpit; a circular concentric apparatus including a plurality of wing segments mounted on the circular concentric apparatus; Each of the plurality of wing segments having a leading edge mounted proximity on the circular concentric apparatus and having a trailing edge mounted distally mounted on the circular concentric apparatus; and a stepper motor connected to a generator drive the stepper motor and lift the helicopter.

### FIELD OF THE INVENTION

The present invention refers to an improved propulsion system for a vehicle for example a helicopter-type device.

### BACKGROUND

On a helicopter the main rotor or rotor system is the combination of several rotary wings (rotor blades) with a control system, that generates the aerodynamic lift force that supports the weight of the helicopter, and the thrust that counteracts aerodynamic drag in forward flight. Each main rotor is mounted on a vertical mast over the top of the helicopter, as opposed to a helicopter tail rotor, which connects through a combination of drive shaft(s) and gearboxes along the tail boom. The blade pitch is typically controlled by the pilot using the helicopter flight controls. Helicopters are one example of rotary-wing aircraft (rotorcraft). The name is derived from the Greek words helik-, meaning spiral; and pteron meaning wing. The helicopter is able to fly based upon the rotor which is powered by the engine, through the transmission, to the rotating mast. The mast is a cylindrical metal shaft that extends upward from-and is driven by-the transmission.

At the top of the mast is the attachment point (colloquially called a Jesus nut for the rotor blades called the hub. The rotor blades are then attached to the hub, and the hub can have 10-20 times the drag of the blade. Main rotor systems are classified according to how the main rotor blades are attached and move relative to the main rotor hub. There are three basic classifications: rigid, semi rigid, and fully articulated, although some modern rotor systems use a combination of these classifications. A rotor is a finely tuned rotating mass, and different subtle adjustments reduce vibrations at different airspeeds/The rotors are designed to operate at a fixed RPM (within a narrow range of a few percent), but a few experimental aircraft used variable speed motors

Unlike the small diameter fans used in turbo fan engines, the main rotor on a helicopter has a large diameter that lets it accelerate a large volume of air, This permits a lower downwash velocity for a given amount of thrust As it is more efficient at low speeds to accelerate a large amount of air by a small degree than a small amount of air by a large degree, a low disk loading (thrust per disc area) greatly increases the aircraft's energy efficiency, and this reduces the fuel use and permits a reasonable range. The hover efficiency (“figure of merit”) of a typical helicopter is around 60%. The inner third length of a rotor blade contributes very little to lift due to its low airspeed.

Any highly spinning object which has a mass is primarily a Gyro. For example a spinning wheel, a fired bullet a propeller oval plane etc. A gyroscope is a mechanism which has a high spinning speed, mass and at least 3° of freedom.

The 3° of freedom in the gyroscope should be able to rotate on its axis which may be called the spin axes. The gyroscope should be able to drift on the vertical axis and it should be able to tilt on the horizontal axis. FIG. 4 illustrates a Gyro rotatable on the vertical axis and able to be tilted on the horizontal axis. The Gyro should be able to rotate on its spin axes.

### Summary

A helicopter transporting at least one user, including
a cockpit for carrying at least the one user or remotely controlled;
a circular concentric apparatus (CCA) being connected to the cockpit;
a circular concentric apparatus including a plurality of wing segments mounted on the circular concentric apparatus;

Each of the plurality of wing segments having a leading edge mounted proximity on the circular concentric apparatus and having a trailing edge mounted distally on the circular concentric apparatus; and a stepper motor connected to a generator drive which drives the wings within the circular concentric apparatus to lift the helicopter; the stepper motor and lift the helicopter.

The stepper motor includes at least one magnet.

The magnets are positioned exterior or interior to the circular concentric assembly.

The magnets are configured to be sequentially energized around the circular concentric assembly.

The trailing edge is configured to be narrower than the leading edge.

The at least one wing segment which varies in thickness.

The helicopter includes a gimbal having at least 3° of freedom.

The gimbal is configured to be attached to a rotor of the stepper motor.

The spin axis of the CCA is configured to be attached to the rotor of the stepper motor.

### BRIEF DESCRIPTION OF THE DRAWINGS

The invention may be understood by reference to the following description taken in conjunction with the accompanying drawings, in which, like reference numerals identify like elements, and in which: FIG. 1 illustrates a cross-sectional view of the rotor of the present invention;

FIG. 2 illustrates a side view of the assembled hover craft of the present invention;

FIG. 3 illustrates a side view of the wing segment of the present invention;

FIG. 4 illustrates a conventional gyroscope;

FIG. 5 illustrates a gyroscope according to the teachings of the present invention;

FIG. 6 illustrates a gyroscope according to the teachings of the present invention;

FIG. 7 illustrates a top view of the magnetic driven wing assembly;

FIG. 8 illustrates a stepper motor of the present invention;

FIG. 9 illustrates another stepper motor of the present invention;

FIG. 10 illustrates another stepper motor of the present invention;

FIG. 11 illustrates a cross-sectional view of the magnetic driven wing assembly;

FIG. 12 illustrates a side view of the wing segment;

FIG. 13 illustrates a top view of the wing segment;

FIG. 14 illustrates a side view of the magnetic driven wing assembly;

### DETAILED DESCRIPTION

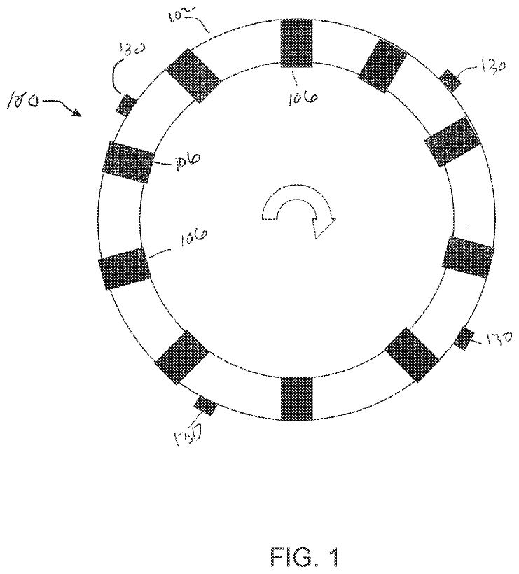

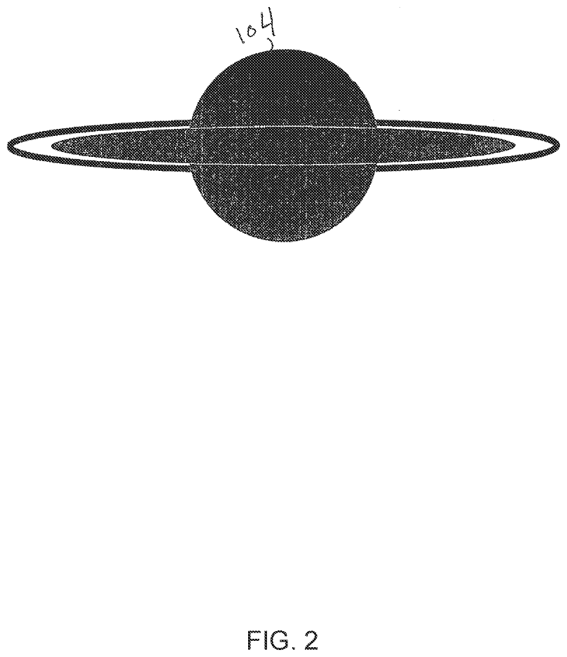

FIG. 1 illustrates a magnetic driven wing assembly 100 which may be driven by a motor and transmission and which includes a main rotor 102 for a flying machine 104 as shown in FIG. 2 which incorporate wing segments 106 which are similar to the sections of a conventional helicopter (not shown). The present invention includes a circular concentric assembly (CCA) 108 to mount the wing segments 106 at equidistant positions around the CCA 108. The CCA 108 is moved by a multitude of magnets 110 positioned around the exterior of the CCA 108, avoiding the use of a central rotor shaft. The magnets 110 are preferably positions equidistant around the CCA 108. The magnets 110 are energized in sequence in order to move the CCA 108.

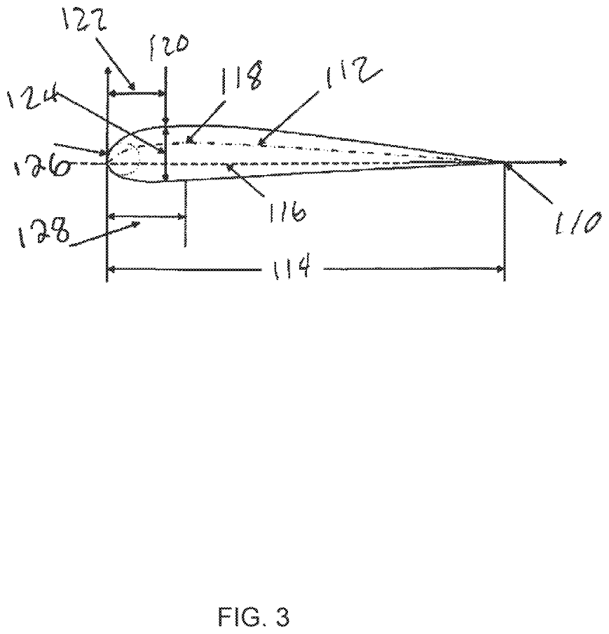

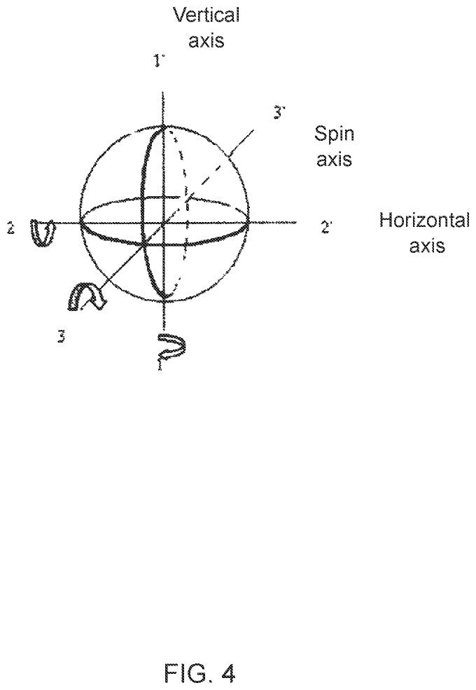

FIG. 3 illustrates a side view of a wing segment 106 of the present invention. The wing segment 106 of the present invention includes a leading edge 126 which is connected to a trailing edge 110 which is narrower than the leading edge 126, and FIG. 3 illustrates a cord line 116 which may extend from trailing edge 110 to the leading edge 126. The cord distance 114 may extend from the trailing edge 110 to the leading edge 126. The location of the maximum camber is illustrated by element 128. The upper surface of the wing segment 106 increases until the location of maximum thickness 122 and decreases from the maximum thickness 120 to the trailing edge 110. The thickness 124 reaches the maximum at the maximum thickness 120.

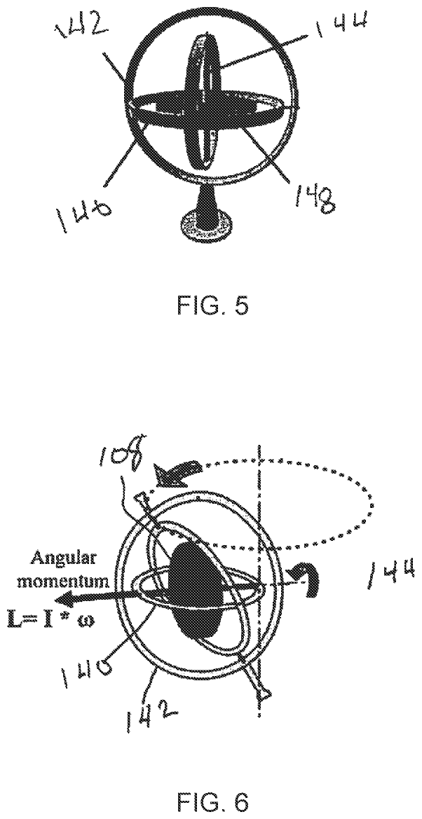

FIG. 5 and FIG. 6 illustrate the gyroscope of the present invention. FIG. 5 illustrates a gyroscope frame 142. The gimbal 140 is a pivoted support that permits rotation of an object about an axis which may be a circular band which is attached to the gyroscope frame 142 the rotor 108 is attached to the spin axes 144 of the gyroscope.

FIG. 6 illustrates the gimbal 140 the gyroscope frame 142, the rotor 108 mounted within the horizontal axis, the vertical axis and the spin axis of the gyroscope frame 142.

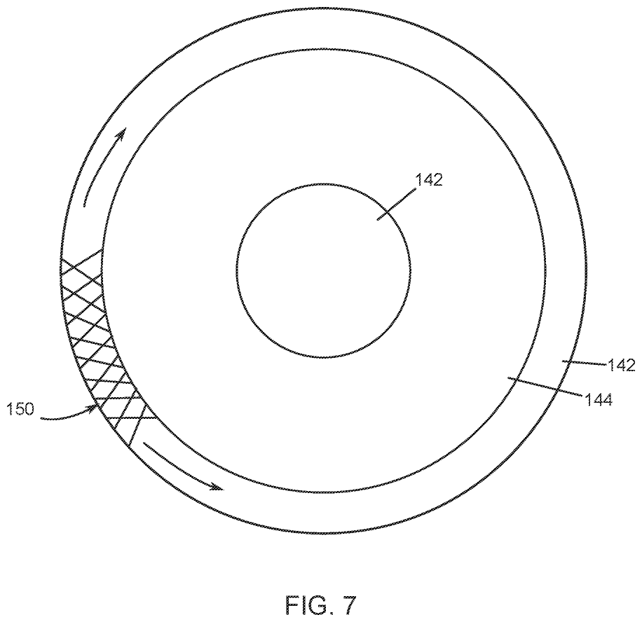

FIG. 7 illustrates a top view of the wing assembly 100, the wing assembly arm 144 and the cockpit 142.

A stepper motor is not rotated by the central rotating head but instead is advanced by the magnets positioned on the outer circumference of the device.

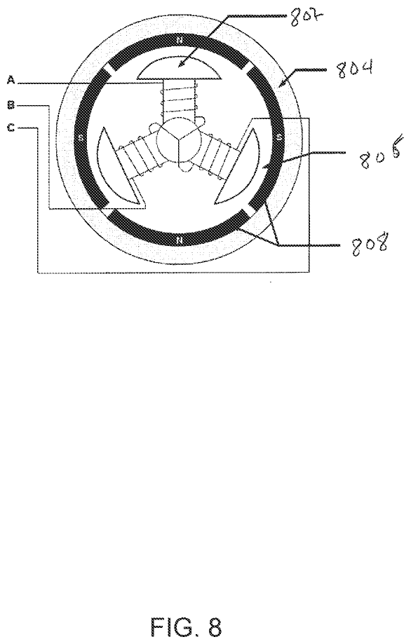

FIGS. 8, 9 and 10 are diagrams of hard disk stepper motors. In FIG. 8 a stepper motor is illustrated with a stator 804 position within the airgap 805 and illustrates a rotor 804 surrounding the permanent magnets 808.

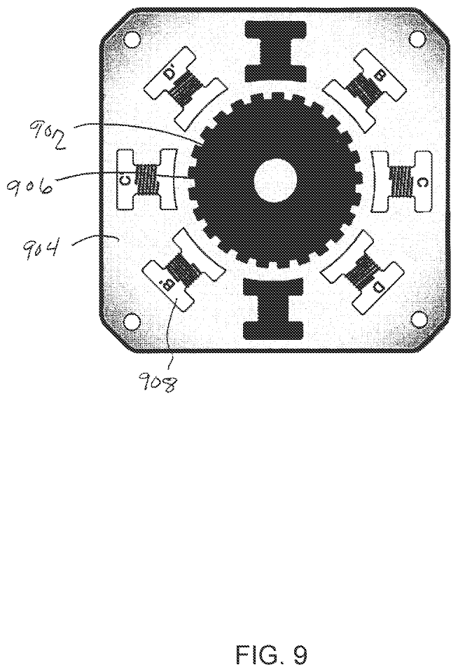

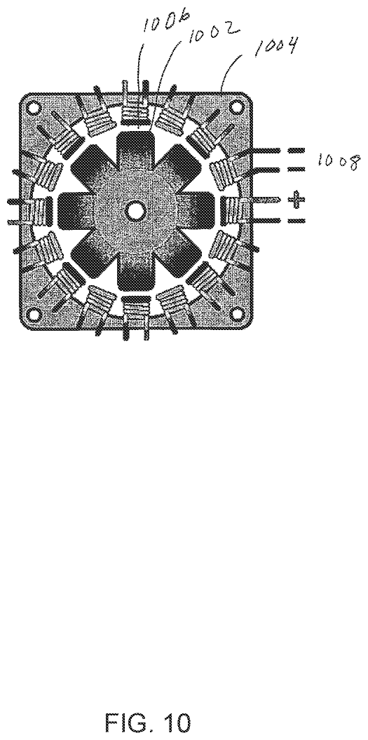

FIG. 9 illustrates another stepper motor including a stator 902, the rotor 804 the airgap 906 In FIG. 10 a stepper motor is illustrated with a stator 1004 position within the airgap 1005 and illustrates a rotor 1004 surrounding the permanent magnets 1008.

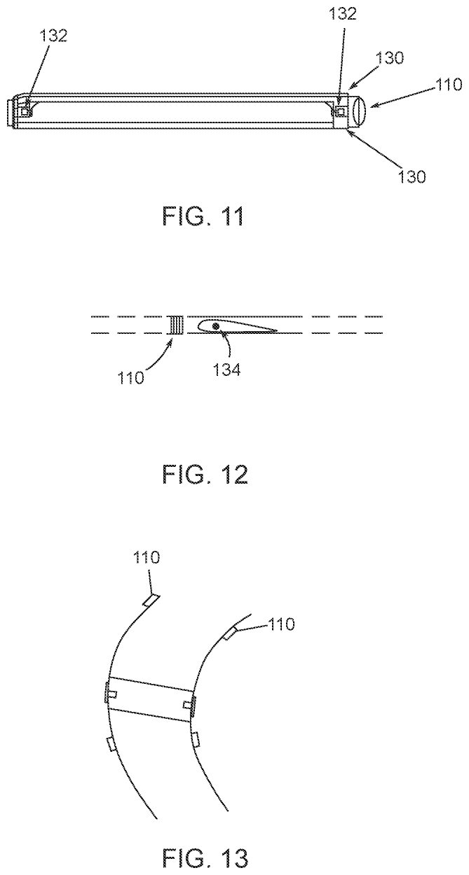

FIG. 11 illustrates a side view of the cross-section of the magnetic driven wing assembly 100. FIG. 11 additionally illustrates the electro magnetic 110 positioned on the outer ends of the magnetic driven wing assembly 100. The frame 130 includes a roller bearing track 132 positioned at each end of the frame 130.

FIG. 12 illustrates a side view of the wing segment 106 and the roller bearing 134 which travels within the roller bearing track 132. FIG. 11 additionally illustrates the magnet 110 mounted on frame 130.

FIG. 13 illustrates a top portion of a portion of the magnetic driven wing assembly 100 which shows a magnet 110 positioned both inside and outside of the magnetic driven wing assembly 100. Additionally, roller bearings 134 are illustrated in FIG. 13.

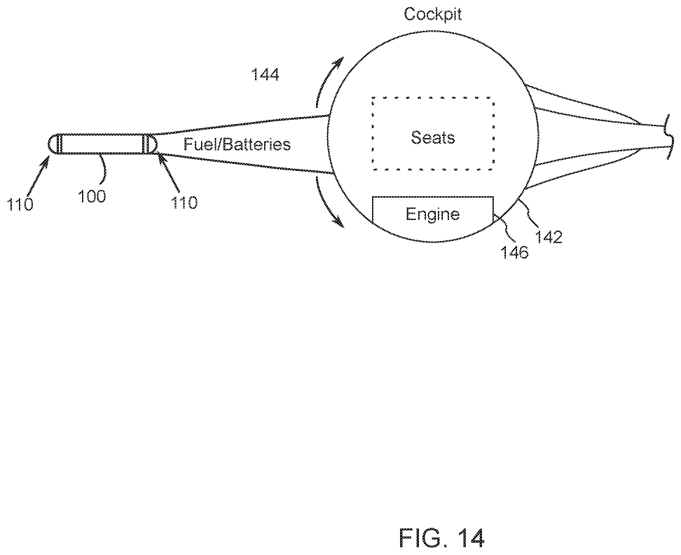

FIG. 14 illustrates the magnetic driven wing assembly 100 and shows magnets 110 positioned on the inside and outside end of the wing assembly 100 and illustrates a roller bearing track 132 which may be rails for the roller bearings 134 to ride on. FIG. 14 additionally illustrates a cockpit 142 which may include seats for the crew and an engine 146 to drive the magnets 110. The wing assembly 100 may be attached to a wing assembly arm 144 which may be a disk and which may connect the (pivotably) moving along the surface of the cockpit 142. The wing assembly arm 144 may be hollow in order to store fuel and/or batteries.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A helicopter transporting at least one user, comprising
a cockpit for carrying at least the one user;
a circular concentric apparatus (CCA) being connected to the cockpit;
a circular concentric apparatus including a plurality of wing segments mounted on the circular concentric apparatus;
Each of the plurality of wing segments having a leading edge mounted proximity on the circular concentric apparatus and having a trailing edge mounted distally on the circular concentric apparatus; and
a stepper motor connected to a generator configured to drive the stepper motor and lift the helicopter.

2. A helicopter transporting at least one user as in claim 1, wherein the stepper motor includes at least one magnet.

3. A helicopter transporting at least one user as in claim 2 wherein the magnets are positioned exterior to the circular concentric assembly.

4. A helicopter transporting at least one user as in claim 3 wherein the magnets are configured to be sequentially energized around the circular concentric assembly.

5. A helicopter transporting at least one user as in claim 1, wherein the trailing edge is configured to be narrower than the leading edge.

6. A helicopter transporting at least one user as in claim 1, wherein the at least one wing segment varies in thickness.

7. A helicopter transporting at least one user as in claim 1 wherein the helicopter includes a gimbal having at least 3° of freedom.

8. A helicopter transporting at least one user as in claim 7, wherein the gimbal is configured to be attached to a rotor of the stepper motor.

9. A helicopter transporting at least one user as in claim 8, wherein a spin axis is configured to be attached to the rotor of the stepper motor.

10. A helicopter being remotely controlled, comprising
a cockpit;
a circular concentric apparatus (CCA) being connected to the cockpit;
a circular concentric apparatus including a plurality of wing segments mounted on the circular concentric apparatus;
Each of the plurality of wing segments having a leading edge mounted proximity on the circular concentric apparatus and having a trailing edge mounted distally on the circular concentric apparatus; and
a stepper motor connected to a generator configured to drive the stepper motor and lift the helicopter.

11. A helicopter transporting at least one user as in claim 2 wherein the magnets are positioned interior to the circular concentric assembly.
